(19) United States
(12) Patent Application Publication
(10) Pub. No.: US 2003/0075054 A1
(43) Pub. Date: Apr. 24, 2003

(54) Rack of lamb bone clip

(76) Inventors: Joseph Masseria, Chagrin Falls, OH (US); Albert L. Harlow JR., Chagrin Falls, OH (US)

Correspondence Address: Mr. Charles R. Steffel, 281 South Syndicate Street, Saint Paul, MN, 55105-2812, US

(21) Appl. No.: 10/004,392

(22) Filed: Oct. 22, 2001

(51) Int. Cl. A23P 1/00; A47J 37/04

(52) U.S. Cl. 99/426; 99/419

(57) ABSTRACT

A rack of lamb bone clip includes a pair of generally t-shaped clip members held in pivotal engagement by a spring means. Each clip member includes a widened jaw, a handle and a centrally disposed pivot portion attached to the spring means and a series of gripping teeth generally parallel to a forward edge of the jaw opposing the handle. The bone clip having widened jaws being pivotally interconnected being movable between a closed gripping position in contact with each other and an open nongripping position not in contact with each other upon the application or release of a squeezing compressive force upon the handles. When the handles are released, the spring means forces the jaws and gripping teeth toward each other, the jaws and teeth grip the bones of a rack of lamb, and clip members protect the bones from heat and flames during cooking. The torsion coil spring means provides sufficient force to provide firm grip by the jaws of the bone clip allowing suspension of the handle members from a pair of tongs for transporting the bone clip and bones and meat to and from a brazier grill or oven. A method for cooking a rack of lamb utilizing a bone clip includes steps of: covering the bone portion of the rack with a bone clip, lifting the rack secured in the clip, moving the bone clip and the rack into a cooking apparatus, moving the bone clip and the rack inspection of doneness and removal of the rack from bone clip after completion of cooking.

### BACKGROUND OF THE INVENTION

The cooking of a rack of lamb employs high heat is a gas powered grill or an oven. The bone protector of the present invention employs a removable metal shield to protect the bones while cooking. Cooking raises a large amount heat and flames from a gas grill and flames due to searing and cooking of fatted meats. The flames and excessive heat damage the rack of lamb and other ribbed meat causing the bones to be burn and char and fall apart thus spoiling the presentation of the dish.

A previous method of protecting bones includes using shields of aluminum foil placed around leg bones while cooking. The aluminum foil shield added difficulty when moving the meat. Observation on doneness of the bones was very difficult when the bones were obstructed by the makeshift heat shield.

The apparatus and method facilitates the use of tongs to lift the handles of the bone clip and move the rack meat and bone that is secured within the bone clip. The use of tongs is very helpful in moving the rack of lamb to and from the oven or grill. Tongs may rip or destroy the makeshift heat shield provided by folded aluminum foil shielding.

### SUMMARY OF THE INVENTION

A rack of lamb bone clip including a pair of generally t-shaped clip members held in pivotal engagement by a spring means. Each clip member includes a widened jaw ,a handle and a centrally disposed pivot portion attached to the spring means and a series of gripping teeth generally parallel to a forward edge of the jaw opposing the handle. The bone clip having widened jaws being pivotally interconnected being movable between a closed gripping position in contact with each other and an open nongripping position not in contact with each other upon the application or release of a squeezing compressive force upon the handles. When the handles are released, the spring means forces the jaws and gripping teeth toward each other, the jaws and teeth grip the bones of a rack of lamb, and clip members protect the bones from heat and flames during cooking.

The torsion coil spring means is provides sufficient force to provide firm grip by jaws of the bone clip allowing suspension of the handle members from a pair of tongs or the like for transporting the bone clip and attached bones and meat to and from a brazier grill or oven.

A generally T shaped bone clip molded or stamped from metal preferably stainless steel offers protection of the bones of a rack of lamb from the hear of flames on a grill brazier or oven while the rack of lamb is cooked.

Tension spring means urges the jaws together so that the clip stays firmly attached to the rack of lamb. Teeth near the edge of the jaws bite into the rack of lamb so the clip has a firm grip on the lamb while the lamb is repositioned in the oven by the chef. The clip is made of stainless steel and has a small viewing window between the handles. The window allows viewing to make sure that the bone is properly attached as desired by the chef.

The teeth are made to grip the bones with out damaging the bones that are protected from flames. Teeth may be made perpendicular to the jaws, inclined “upward” toward the pivot as shown or downward toward the edge of the jaw.

To allow for simple manufacturing of the clip using two substantially alike clip members, teeth may be made by a punch press in an offset pattern. The offset punch press pattern may include forming the wing sections on the centrally disposed pivot portion. Spring hooks attached to the centrally disposed pivot portion function as a pivot pins that extend through a central coiled portions of torsion spring means. Dual punch pressed wing sections support spring hooks.

A method for cooking a rack of lamb utilizing a bone clip includes steps of: covering the bone portion of the boned meat with a bone clip, lifting the boned meat secured in the clip, moving the bone clip and boned meat into a cooking apparatus, optionally moving the bone clip and boned meat as needed for inspection of doneness, removing the bone clip and the secured rack from the cooking apparatus; and removal of the boned meat from bone clip after completion of cooking. The method permits allows for the use of tongs to lift the clip and boned meat that is secured within the bone clip. The bone clip holds the meat together for transport to serving dishes permitting a good presentation of the cooked meat.

Other advantages and meritorious features of the present invention will be more fully understood from the following description of the drawings and the preferred embodiments, the appended claims and the drawings that are described herein below.

### BRIEF DESCRIPTION OF THE DRAWINGS

FIG. 1 is a perspective view, partially broken away, of the bone clip of the present invention;

FIG. 2 is an exploded view of the bone clip of the present invention;

FIG. 3 is a side view of the bone clip of the present invention, shown in the closed position, enlargement A shows the wings, pin, and spring; enlargement B shows the jaws and teeth, a uncompressed helical coil torsion spring stands alone;

FIG. 4 is a side view of the bone clip of the present invention, shown in the closed position with a boned portion of meat between the jaws; enlargement A shows the wings, pin, and spring; enlargement B shows the jaws and teeth;

FIG. 5 is a view of the bone protector from the handle end;

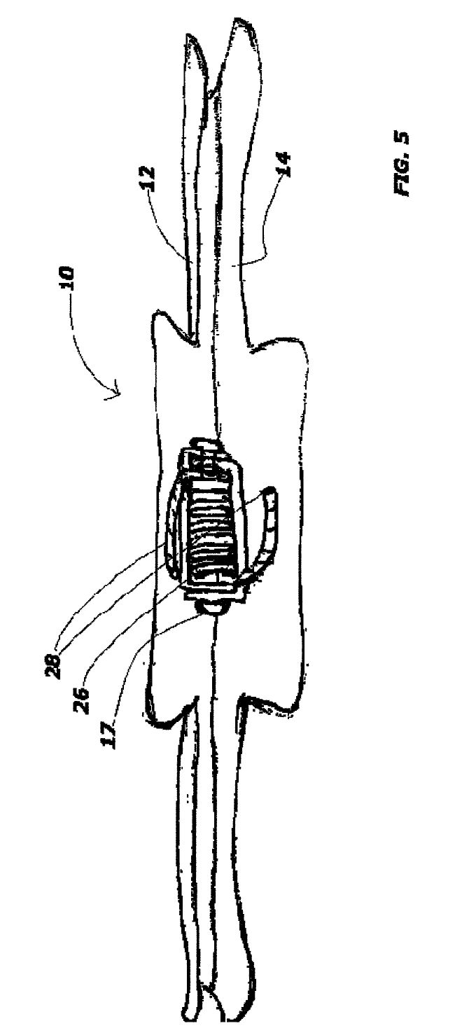

FIG. 6 is a view of the dual spring bone protector as seen the from the handle end.

### DESCRIPTION OF THE PREFERRED EMBODIMENTS

With this detailed description of the specific structure used to illustrate the preferred embodiments of the present invention and the operation thereof, it will be obvious to those skilled in the art that various modifications can be made in both the shape and structure of the bone clip 10, clip members 12 and 14, pivot pin 17 and in the arrangement, structure and number of spring means 13 employed in the pin 17 and wing sections 30 and 32 without departing from the spirit and scope of the invention which is limited only by the appended claims.

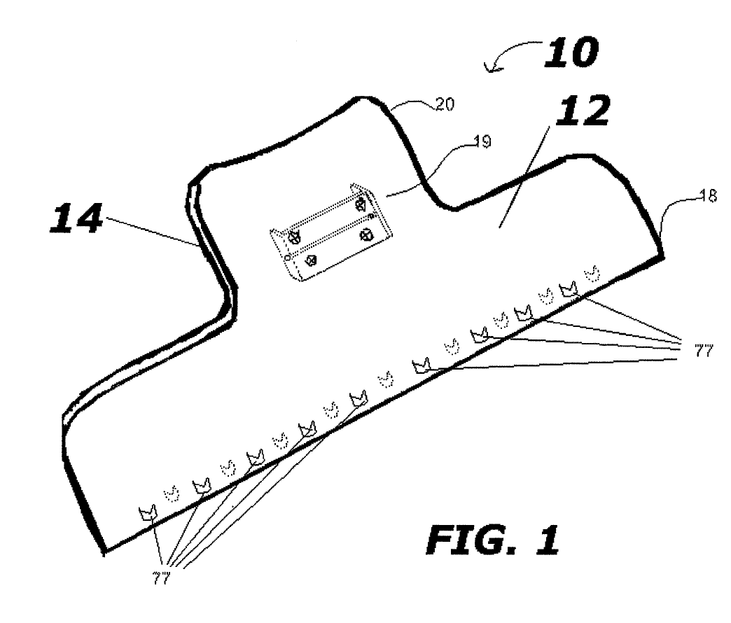

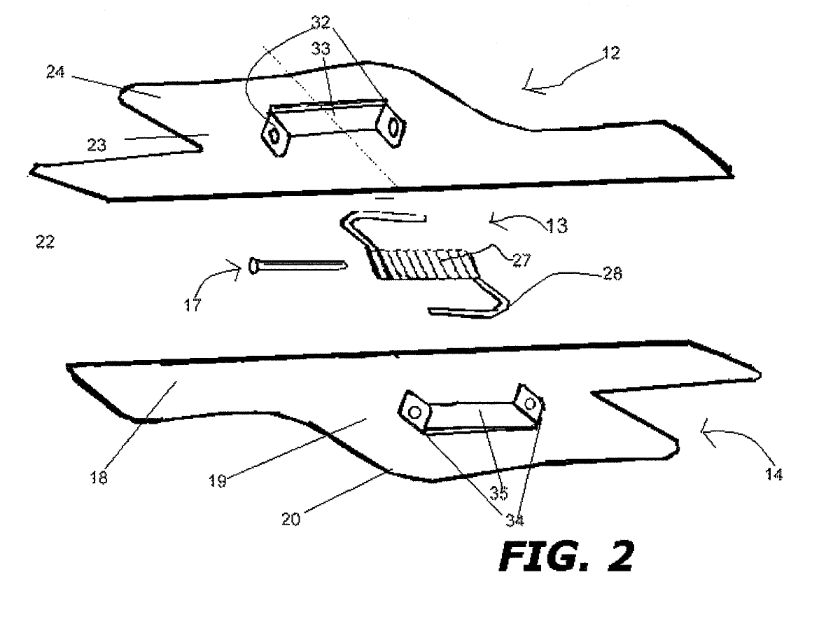

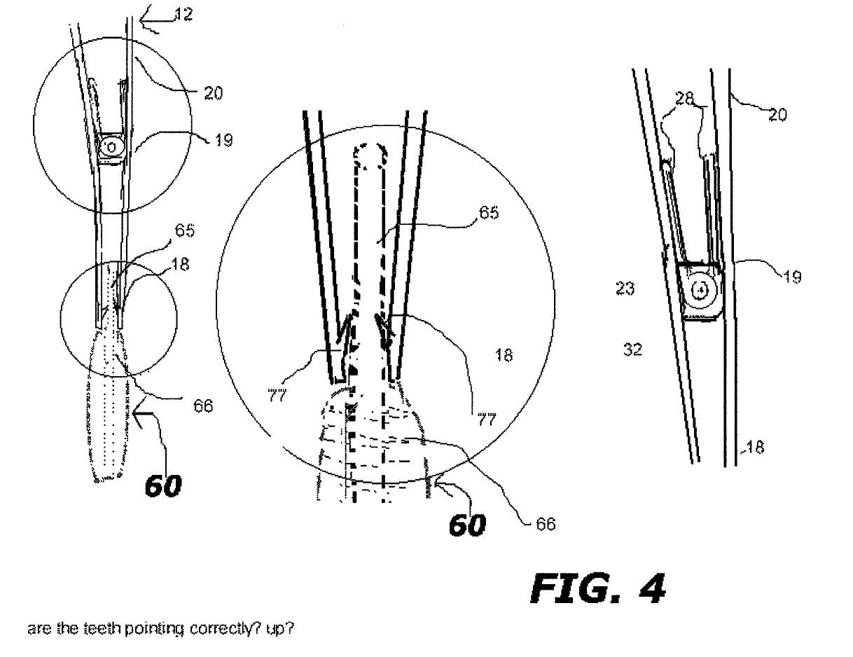

As shown in FIGS. 1-3, the bone clip assembly 10 includes a clip member 12 pivotally attached to a second substantially identical clip member 14 by a pivot pin or rivet 17. The first clip member 12 defining a widening jaw portion 18, a centrally disposed pivot portion 19 and a handle portion 20. The second clip member 14 is similarly constructed with a widening jaw portion 22 a centrally disposed pivot portion 23 and a handle portion 24. The bone clip members 12 and 14 are made of a metallic material or heat deflecting material. Preferably, the metallic stainless steel or similar metal that is able to withstand and reflect heat and deflect flames is used. As shown in FIG. 2-4, a torsion spring 13 is mounted about the rivet 17 (FIGS. 4) and has a pair of legs 28 which operably engage the respective handle portions 20, 24 of the clip members 12, 14. Thus, the spring 13 normally urges the handle portions 20, 24 apart and the jaw portions 18, 22 together. To force the jaw portions 18, 22 apart, a user grips the handle portions 20, 24 and forces them together.

Preferably, the rivet 17 extends through spaced apart wing sections 30 on the first aperture assembly on first clip member 12 and through the spaced apart wing sections 32 on the second aperture assembly on clip member 14. The wing sections 30 extend from the centrally disposed pivot portion 19 between the jaw portions 18 and handle portion 20 of the first clip member 12 toward the second clip member 14. Similarly, the wing sections 32 extend from the centrally disposed pivot portion 23 between the jaw portion 22 and the handle portion 24 of the second clip member 14 toward the first clip member 12.

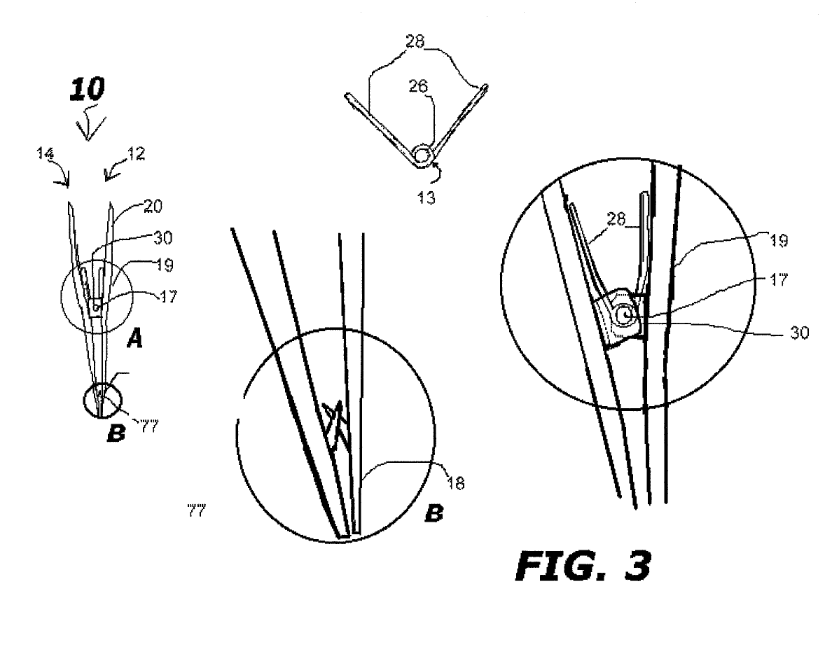

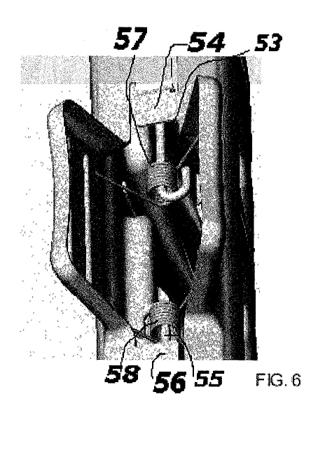

FIG. 2 shows the wing sections 30 and similar wing sections 32 are parts of an aperture assembly attached to the clip members 12 and 24 extending in a flanged fashion from the a centrally disposed pivot portions 19 and 23. The wing sections in FIG. 3 are parts of an aperture assembly 15 that are spot welded, soldered, or brazed to the centrally disposed pivot portions. FIG. 6 shows wing sections 54 and 56 and flanges integral to the

The first aperture assembly comprises a base portion 31 that is attached to the centrally disposed pivot portion 19 and wing sections 30 extending therefrom having apertures for the pin 17. Likewise, the second aperture assembly comprises a base portion that is attached to the centrally disposed pivot portion 23 and wing sections 32 extending therefrom having apertures for the pin 17.

The spring 13 includes a coiled hollow body portion 26 intermediate first and second elongated leg portions 28. The elongated leg portions 28 may be straight or curved allowing for the wide variety torsion springs available. FIG. 3 shows a free standing uncompressed torsion spring and with the leg portions spread apart.

To allow for simple manufacturing of the clip using two substantially alike clip members, teeth 77 may be made by a punch press in an offset pattern. The partial cutaway in FIG. 1 shows the offset teeth in phantom view.

FIG. 6 shows the offset punch press pattern may form wing sections 54 and 56 as flanges on centrally disposed pivot portions 19 and 23. Spring hooks 53 and 55 are attached to the flanged wing sections 54 and 56 and act as pivot pins that extend through a central coiled portions of a pair of torsion spring means 57 and 58. Spring hooks 53 and 55 are secured by brazing or spot welding. In other possible embodiments, it is suggested that a mechanical friction and compression fastening means secures the spring hook to the flange.

What is not shown by a drawing is a last manufacturing technique that uses wing sections that are formed a s described above by punching flanges, additionally apertures are made in the wing sections and the spring and pivot pin may be added and made secure by riveting the pin or spot welding the pin end on the flange.

A method for cooking a rack of lamb utilizing a bone clip includes steps for covering the bone portion 65 of the rack of lamb 60 meat with a bone clip 10, lifting the bone portion 65 and meat portion 66 secured in the clip 10, moving the bone clip 10 and secured bone portion 65 and meat portion 66 into a cooking apparatus, moving the bone clip 10 and for inspection of doneness and removal of the bone clip 10 after completion of cooking. The apparatus and method facilitates the use of tongs to lift the clip and boned meat that is secured within the bone clip. The use of tongs is very helpful in moving the rack of lamb to and from the oven or grill.

First step is the urging together the handles of the bone clip and spreading the jaws of the bone clip apart. Second step is placing the boned meat that has been prepared for cooking between the jaws of the bone clip. Third step is permitting springs to urge the jaws together gripping the bones so that the exposed bone portions of the meat is secured between the jaws and the meat is uncovered for cooking. Third and fourth steps are lifting and placing the bone clip and bones and meat that have been secured in the bone clip in a heated cooking apparatus. Fifth step is an optional step wherein inspecting the boned meat for completion of cooking is completed by lifting the bone clip. Sixth step is removing the bone clip from the cooking apparatus. The final step is opening the jaws of the bone clip and removing of the cooked bones and meat from the bone clip.

From the foregoing, it will be observed that numerous modifications and variations can be effected without departing from the true spirit and scope of the novel concept of the present invention. It will be appreciated that the present disclosure is intended as an exemplification of the invention, and is not intended to limit the invention to the specific embodiment illustrated. The disclosure is intended to cover by the appended claims all such modifications as fall within the scope of the claims.

What is claimed is:

1. A bone clip for cooking bone connected to meat comprising:
a first clip member pivotally attached to a second clip member by a pivot pin, the first clip and second clip member defining widening jaw portions, the centrally disposed pivot portions and handle portions, wing sections connected to the centrally disposed pivot portions, the wing sections also having apertures for receiving the pivot pin disposed within a coiled hollow body portion of a torsion spring, the spring also having elongated leg portions, the leg portions being placed in compression by movements against the centrally disposed pivot portions of the clip members and the widened jaws being movable between a closed gripping position in contact with each other and an open nongripping position not in contact with each other, and upon the application or release of a squeezing compressive force upon the handles and in transitional positions between the gripping and the non gripping positions when the handles are released, the spring means forces the jaws and gripping teeth toward each other, whereby the jaws grip the bones connected to the meat, and clip members protect the bones from heat and flames during cooking.

2. The bone clip as described in claim 1, wherein the widened jaw portions have teeth located near forward jaw edges for enhanced gripping of the bones.

3. The bone clip as described in claim 1, wherein the wing sections are connected to base portions that have a connecting means for securing the centrally disposed pivot portions to the base portions connected to the wing sections.

4. The bone clip as described in claim 3, wherein the connecting means is chosen from the group consisting of brazing, soldering or spot welding.

5. The bone clip as described in claim 1, wherein the wing sections are integrally formed from the first and second clip members by a manufacturing process that includes the steps of bending flanges toward the opposing clip members and forming apertures in the bent flanges for receiving the pivot pin in the wing sections.

6. The bone clip as described in claim 5, wherein the widened jaw portions have teeth located near forward jaw edges for enhanced gripping of the bones.

7. A method for cooking a rack of lamb utilizing a bone clip having jaws for gripping and
heat protection comprising the steps of:
spreading the jaws of the bone clip apart;
covering the bone portion of the rack with a bone clip and securing the bone portion in the jaws of the bone clip;
lifting the rack secured in the bone clip,
moving the bone clip and the secured rack into a cooking apparatus;
removing the bone clip and the secured rack from the cooking apparatus;
and removing the bone clip from the cooked rack from bone clip after completion of cooking.
